(19) United States
(12) Patent Application Publication
(10) Pub. No.: US 2015/0293650 A1
(43) Pub. Date: Oct. 15, 2015

(54) ENHANCEMENT OF PRESENTATION OR ONLINE COLLABORATION MEETING

(71) Applicant: Vadim Dukhovny, Petah Tikva (IL)

(72) Inventor: Vadim Dukhovny, Petah Tikva (IL)

(21) Appl. No.: 14/349,084

(22) PCT Filed: May 16, 2012
(86) PCT No.: PCT/IB2012/052465

§ 371 Date: Aug. 13, 2014

Related U.S. Application Data
(60) Provisional application No. 61/457,719, filed on May 18, 2011.

(51) Int. Cl. G06F 3/0482; G06F 3/0484; H04L 29/06; G06Q 10/10

(52) U.S. Cl. CPC G06F 3/0482; G06Q 10/103; G06F 3/04847; G06F 3/04842; H04L 65/403

(57) ABSTRACT

An interactive presentation and collaboration system and method comprising detecting a presentation window being displayed on a computer display; detecting all the shapes in said presentation window; breaking down each one of said detected shapes into logical shapes; receiving user commands pertaining to a selected one or more of said logical shapes; and changing said displayed presentation window according to said user command. The invention also comprises design-time tools for presentation enhancement.

### CROSS-REFERENCE TO RELATED PATENT APPLICATIONS

This patent application claims priority from and is related to U.S. Provisional Patent Application Ser. No. 61/627,837, filed Oct. 19, 2011, this U.S. Provisional Patent Application incorporated by reference in its entirety herein.

### TECHNICAL FIELD

The present invention relates to software applications used in presentations meetings. Specifically, the present invention relates to enhancement of software applications with detectable objects and it proposes improved method and system for design time and presentation-time interaction with objects of the presentation.

### BACKGROUND OF THE INVENTION

Making presentations, on-line collaborations and conducting meetings are important aspects of many occupations. Executives make presentations to directors, managers conduct meetings with staff, salespersons make presentations to potential customers, physicians conduct meetings with nurses, lawyers make presentations to juries, and so on. Such presentations may take the form of a roundtable, some may be on stage in front of large audience and some may be over an on-line collaboration meeting (webinar) serving thousands of connected participants. A great many professionals conduct and attend meetings and presentations regularly. Much effort therefore goes into creating and delivering effective presentations and preparing for and conducting effective meetings.

With specialized software, conventional personal computers and on-line collaboration tools provide effective platforms for creating and conducting presentations and meetings. Currently available presentation and collaboration program modules can turn a personal computer into a customized presentation system for creating and delivering presentation meetings. The presenter in these presentation meetings may choose a software application that in his opinion should in the best way convey his message to his audience during the presentation meeting. For example, a salesperson may choose for his pitch a slide presentation application (e.g. Microsoft PowerPoint, Apple KeyNote, Google Docs Presentation, etc.); finance people and project managers may choose spreadsheet application (e.g. Microsoft Excel, Google Docs Spreadsheet, etc.), engineers may choose text processing application (e.g. Microsoft Word, Google Docs document, etc.), scientists may choose PDF application (e.g. Adobe Acrobat) and so on. The common characteristic of many presentation applications is that they have detectable objects (shapes). For example, Microsoft PowerPoint's detectable objects are text blocks, pictures, etc.; Microsoft Excel's detectable objects are cells, pictures, graphs, tables; Microsoft Word's detectable objects are paragraphs, pictures, tables, etc. . . . Many applications have only one operation mode (WYSIWYG (What You See Is What You Get), e.g. Excel, Word), while in other applications there is a special presentation/show mode (e.g. PowerPoint slide-show mode). In this presentation mode (slide-show mode), the presenter has no ability to interact with the slide objects; in other (WYSIWYG) applications the presenter has very limited options to interact with the application objects, e.g. he can only highlight, select, zoom entire displayed document, etc.

A presentation or online collaboration meeting (webinar, e.g. Cisco WebEx, Microsoft LiveMeeting, Adobe Acrobat Connect, Skype, etc.) may be enhanced by the ability to detect objects (shapes) in the presented file in real-time during the course of the presentation or online collaboration meeting, allowing the presenter to interact with these detected objects(shapes) in real-time. The ability to detect and act upon these objects in the course of an on-line collaboration meeting, where the presenter's body language is hidden and all the participants see is the shared screen, is of significant value on top of the currently used tools.

For ease of articulation, we will use the terms “slide”, “slide show” and “presentation” in the following text, in their broader meaning as to refer to “page displayed”, “run-time presentation mode” and “viewable screen”, respectively, not limiting our discussion to any specific software of computerized facility that incidentally adopted these terms in its own conventions.

### Logical Shape Definition

Each presentation application screen/canvas consists of one or more shapes (objects). Examples of shapes are text block (e.g. MS-Word, MS-PowerPoint), placeholder (e.g. MS-Word, MS-PowerPoint), table (e.g. MS-Excel, MS-PowerPoint, MS-Word), picture (e.g. MS-Word, MS-PowerPoint, Adobe Acrobat), video (e.g. MS-PowerPoint, Adobe Acrobat), etc. A logical shape is defined herein as a sub-component of a shape or the shape itself. For example, one text block or placeholder shape may hold many paragraphs—each paragraph is actually a separate logical shape. Another example is when one table shape consists of many cells, rows and columns. Each cell, row, column and the whole table itself are all separate logical shapes.

In order to go further and answer some specific needs, one big logical shape may be divided into a number of smaller logical shapes. E.g. a paragraph may be divided into words; a word may be divided into characters and so on. FIG. 1 shows an example of the object module in MS-PowerPoint, comprising a presentation 100, a plurality of presentation slides 110, a plurality of animation builds 120 for each slide (build is the animation phase for the current slide, each click in multi-click animation invokes the next build), a plurality of presentation system shapes 130 for each animation build such as textbox, table, picture, etc. and a plurality of logical shapes for each system shape such as paragraph, cell, row, column, etc.

For example, the speaker may wish to refer to some specific logical shape (e.g. picture, paragraph, cell, row, column, etc.) while conducting a slide presentation in the slide show mode. It would therefore be advantageous, especially when the presented slide contains many shapes, if the presentation application or an add-on thereto, hereinafter referred to as “presentation system” would recognize such logical shapes on the slide being displayed during the course of the presentation in the slideshow mode. Once recognized, the speaker may act upon these shapes to highlight or shade a logical shape or a number of logical shapes, change highlight color, magnify, blur, erase, attach sticky note/action item or perform some other operation on logical shape(s) of choice to help clarify the presented material.

In addition, it would be advantageous if the presentation system could guess the navigation pattern between all logical shapes presented in the current screen. This will enable the speaker to easily support his presentation flow by navigating from one shape to another—forward and backward (e.g. by rotating mouse scroll wheel, pressing Tab/Shift+Tab, etc.). The presentation system could also automatically advance to the next screen once navigating through all logical shapes on the current screen in the forward direction and similarly—display the previous screen upon reaching past the first shape on the current screen in backward direction.

In the case of on-line collaboration meetings (webinars) in which the application used to create the presented file may not provide pre-designed “presentation/show” operating mode (e.g. WYSIWYG applications like MS-Word, MS-Excel), the lack of interactive tools is even more limiting, as the notion of show-time doesn't exists, and the typical application shared was not designed with real-time collaboration and sharing in mind.

Some prior art (e.g. U.S. Pat. No. 5,917,480—Method and system for interacting with the content of a slide presentation) tried to address the need for an improved method and system for interacting with the general content of a slide presentation during the course of the presentation in the slide-show mode, but this was limited to slide-level information (e.g. slide speaker notes, etc.) and did not allow the presenter to interact with the presentation at a deeper level—the presentation system shape level (textbox, table, picture, etc.) or even further at logical shape level (paragraph, cell, row, column, etc.). In addition, this art was limited to MS-PowerPoint only, while other presentable applications for presentation or on-line collaboration meetings were not addressed at all.

### SUMMARY

According to a first aspect of the present invention there is provided an interactive presentation and collaboration system comprising a computer system comprising at least one CPU, memory, a display, at least one input device and at least one storage unit adapted to store at least one presentation, said computer system adapted to run a presentation program and an interactive presentation enhancement module configured to detect a presentation window being displayed on said display; detect all the shapes in said presentation window; break down each one of said detected shapes into logical shapes; receive user commands pertaining to a selected one or more of said logical shapes; and change said displayed presentation window according to said user command.

The user commands may comprise at least one of pointer mode commands and magnifier mode commands.

The pointer mode commands may be selected from the group consisting of: select shape, draw frame, laser pointer and invoking magnifier.

The interactive presentation enhancement module may be further configured to change the displayed presentation window in said select shape mode by selecting from the group consisting of: highlighting said selected shape, changing the dimensions of said selected shape and dimming the display surrounding said selected shape.

The interactive presentation enhancement module may be further configured to change the displayed presentation window in said draw frame mode by dimming the display surrounding said drawn frame.

The selected shape may be a first picture and the interactive presentation enhancement module may be further configured to change the displayed presentation window by displaying entirely or partly a second full resolution picture stored in said presentation, corresponding to said first picture.

The magnifier mode commands may be selected from the group consisting of: displaying a magnified area, changing the zoom of said displayed magnified area, changing the radius of said displayed magnified area and defining one or more static lighted spots on said currently displayed presentation window.

The system may additionally comprise GUI means for configuring the interactive presentation enhancement module.

The configuration GUI means may be configured to define the mode of receiving said user commands and define the display change according to said received user commands.

The interactive presentation enhancement module may be further configured to navigate between all said logical shapes presented in a currently displayed presentation window.

The navigating may comprise navigating between logical shapes contained in another logical shape.

The navigating between logical shapes contained in another logical shape may comprise navigating between one of: cells, rows and columns contained in a table.

The navigating between logical shapes contained in another logical shape may comprise navigating between paragraphs contained in a text box.

The at least one input device may comprise a keyboard and a mouse.

The at least one input device may comprise a touch screen surface of a smartphone, said smartphone comprising communication means adapted for constant communication with said computer, said smartphone adapted to run a client application.

The communication means may be selected from the group consisting of: Wifi, Bluetooth and 3G.

The system may additionally comprise a Bluetooth headset microphone.]

The Bluetooth headset microphone may be adapted to record the voice of a presenter of said presentation.

The system may additionally comprise means for recording all user actions during the presentation and means for correlating said recorded actions with slide or shape information.

The system may additionally comprise means for recording the presenter's face and/or body.

The means for recording the presenter's face and/or body may be selected from the group consisting of: a camera integrated in a smartphone, a camera integrated in a laptop, a webcam and a professional camera.

The system may additionally comprise an amplifier connected with said computer, wherein said Bluetooth headset microphone may be adapted to amplify the voice of a presenter of said presentation by transmitting said voice from the Bluetooth headset to said smartphone running the client application, further on to said computer and to said amplifier.

The system may additionally comprise a Bluetooth headset speaker, said speaker adapted to relay information to a presenter of said presentation during said presentation.

The information may be selected from the group consisting of: time elapsed/remaining, real presentation progress vs. previously projected progress and information pertaining to the currently displayed presentation window.

According to a second aspect of the present invention there is provided an interactive presentation and collaboration method comprising: detecting a presentation window being displayed on a computer display; detecting all the shapes in said presentation window; breaking down each one of said detected shapes into logical shapes; receiving user commands pertaining to a selected one or more of said logical shapes; and changing said displayed presentation window according to said user command.

The user commands may comprise at least one of pointer mode commands and magnifier mode commands.

The pointer mode commands may be selected from the group consisting of: select shape, draw frame, laser pointer and invoking magnifier.

Changing the displayed presentation window in said select shape mode may comprise one of: highlighting said selected shape, changing the dimensions of said selected shape and dimming the display surrounding said selected shape.

Changing the displayed presentation window in said draw frame mode may comprise dimming the display surrounding said drawn frame.

The selected shape may be a first picture and said changing the displayed presentation window may comprise displaying entirely or partly a second full resolution picture stored in said presentation, corresponding to said first picture.

The magnifier mode commands may comprise one of: displaying a magnified area, changing the zoom of said displayed magnified area, changing the dimensions of said displayed magnified area and defining one or more static lighted spots on said currently displayed presentation window.

The method may additionally comprise configuring said interactive presentation method.

The configuring may comprise defining the mode of receiving said user commands and defining the display change according to said received user commands.

The method may additionally comprise navigating between all the logical shapes presented in a currently displayed presentation window.

The navigating may comprise navigating between logical shapes contained in another logical shape.

The navigating between logical shapes contained in another logical shape may comprise navigating between one of: cells, rows and columns contained in a table.

The navigating between logical shapes contained in another logical shape may comprise navigating between paragraphs contained in a text box.

The user commands may be received using a keyboard and a mouse.

The user commands may be received using a touch screen surface of a smartphone, said smartphone being in constant communication with said computer, said smartphone running a client application.

The method may additionally comprise recording the voice of a presenter of said presentation using a Bluetooth headset microphone.

The method may additionally comprise recording all user actions during the presentation and correlating said recorded actions with slide or shape information.

The method may additionally comprise recording the presenter's face and/or body.

Recording the presenter's face and/or body may be done using one of: a camera integrated in a smartphone, a camera integrated in a laptop, a webcam and a professional camera.

The method may additionally comprise amplifying the voice of a presenter of said presentation by transmitting said voice from the Bluetooth headset microphone to said smartphone running the client application, further on to an amplifier connected with said computer.

The method may additionally comprise relaying information to a presenter of said presentation during said presentation using a Bluetooth headset speaker.

The information may be selected from the group consisting of: time elapsed/remaining, real presentation progress vs. previously projected progress and information pertaining to the currently displayed presentation window.

According to a third aspect of the present invention there is provided a computer program product, the computer program product comprising: a computer readable storage medium having computer readable program embodied therewith, the computer readable program configured to: detect a presentation window being displayed on said display; detect all the shapes in said presentation window; break down each one of said detected shapes into logical shapes; receive user commands pertaining to a selected one or more of said logical shapes; and change said displayed presentation window according to said user command.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 shows an example of the object model in MS-PowerPoint and logical shape;

FIG. 2 is a flowchart showing the various steps taken by the module of the present invention in the course of a slide presentation;

FIG. 3 is a first exemplary slide;

FIG. 4 is a an exemplary navigation map of the first slide;

FIG. 5 is a second exemplary slide;

FIG. 6 is a an exemplary navigation map of the second slide;

FIG. 7 is a flowchart of an exemplary algorithm for building of Z-index calculation for a new rectangle;

FIG. 8 is a flowchart of an exemplary algorithm for adding a new shape to the navigation map;

FIG. 9 is a schematic representation of an exemplary system for carrying out the present invention;

FIG. 10 is a flowchart of a mobile application according to the present invention;

FIG. 11 is a schematic representation of another exemplary system for carrying out the present invention;

FIGS. 12 through 15 show exemplary screen captures of a configuration module of the presentation application according to the present invention; and

FIGS. 16 through 18 show an exemplary scenario of a “cluttered” slide divided by the system into two simpler slides.

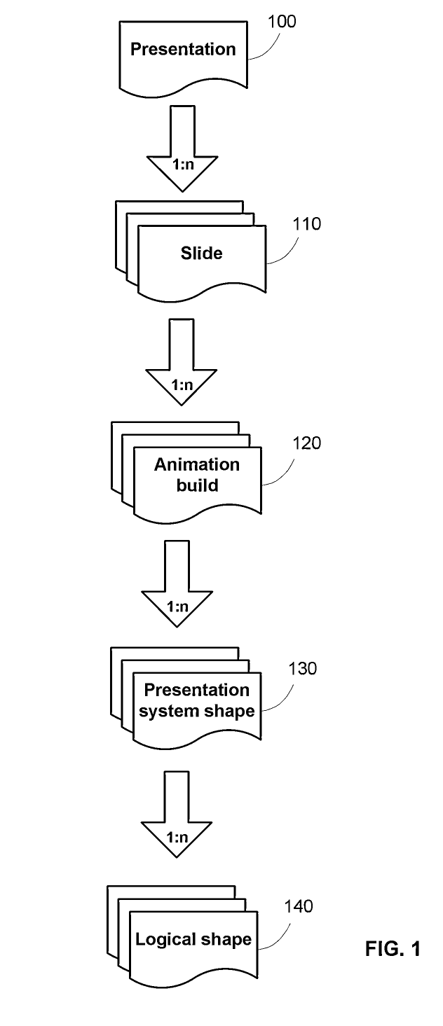

### DETAILED DESCRIPTION OF PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention meets the above-described need by complementing a presentation/collaboration system with an additional interactive module/application that runs as a separate independent application (having its own process) or as a presentation application plug-in or enhancement module (within the presentation application process). This interactive module enhances the presentation application by pre-processing presented application screens/slides in real-time during the presentation meeting and detecting logical shapes on every screen/presentation slide.

In the context of the present invention, the term “presentation application” refers to any application that creates files which may be displayed during a presentation meeting or an online collaboration session, such as MS-Word, MS-Excel, MS-PowerPoint, Adobe Acrobat, Google Docs, etc.

The presentation system according to the present invention will now be explained in detail, in conjunction with Windows platform MS-Office applications (MS-PowerPoint, MS-Word, MS-Excel), sharing a common object model. It is understood that other applications on Windows or other platforms/operating systems (e.g. Adobe Acrobat, Open Office, Google Docs, Office for Mac, etc.) may be similarly adapted by using an appropriate object detection tool/adapter.

The interactive module of the present invention may be easily invoked while the presentation system is in the slide-show mode, either automatically when a slideshow begins or manually by pressing a pre-designated hot keyboard or mouse keys (e.g. middle mouse button). Manual invocation may be used for slide presentation applications, design-time only applications (e.g. MS Word. MS Excel, etc.) or even on an empty desktop (for object-agnostic actions only, e.g. focus on an area, zoom area, etc.).

For example, one possible implementation may be that when the module is invoked, it draws its own transparent or semi-transparent overlay window on top of the presented file window and thus intercepts all user keyboard and mouse events.

Part of these user input events may be transferred transparently to the original presentation application (keeping its original behavior uninterrupted), e.g. left or right arrow buttons, Esc button, etc. and part may be intercepted by the module itself (to perform module specific actions, e.g. enlarging or highlighting a shape, navigating to next shape, invoking lens, playing audio, etc.).

As an example, GUI aspects of the module (transparent or semi-transparent overlay window, user events, etc.) for the Windows platform may be implemented using the WPF (Microsoft Windows Presentation Foundation) technology.

The module may operate in different operating modes. For example, it may take the shape of a pointer mode (the default mode, for interacting with slide shapes), lens mode (for magnifying and lightening different parts of the slide) and so on.

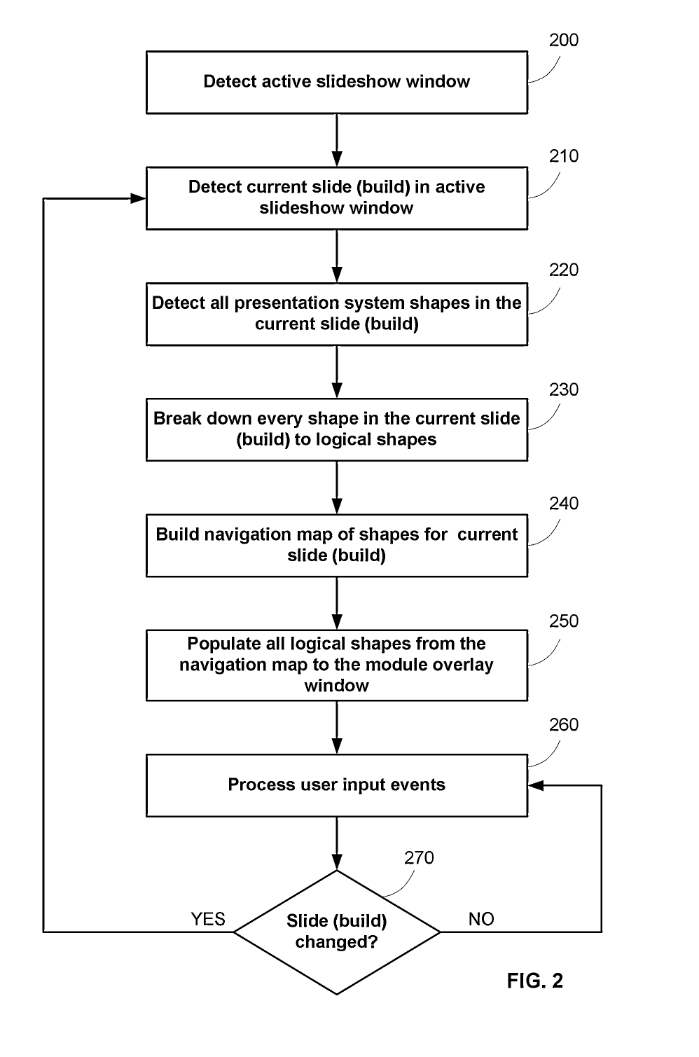

FIG. 2 is a flowchart showing the various steps taken by the module of the present invention in the course of a slide presentation by a slide presentation application (e.g. Microsoft PowerPoint). In step 200, the module automatically detects the presentation system active slideshow window and in step 210 the build of the current slide is detected. In step 220, the module analyzes the slide (build), detects all the presentation system shapes currently in it and their positions on the slide. The build analysis enables the module to identify which phase of the build (animation) the presentation is currently performing, and thus identify only objects currently displayed, i.e. not recognize currently invisible objects. After all slide shapes have been recognized, the module breaks down every shape into its further logical shapes (e.g. text box to paragraphs, table to cells, rows and columns) in step 230.

As an example for Microsoft PowerPoint presentation system, VSTO (Microsoft Visual Studio Tools for Office) technology may be used to accomplish steps 200 through 230.

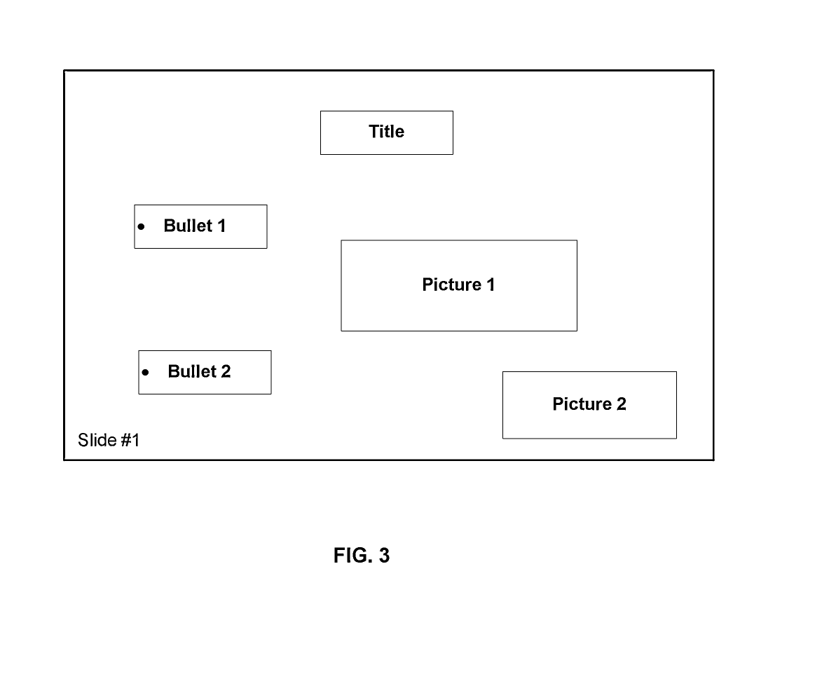

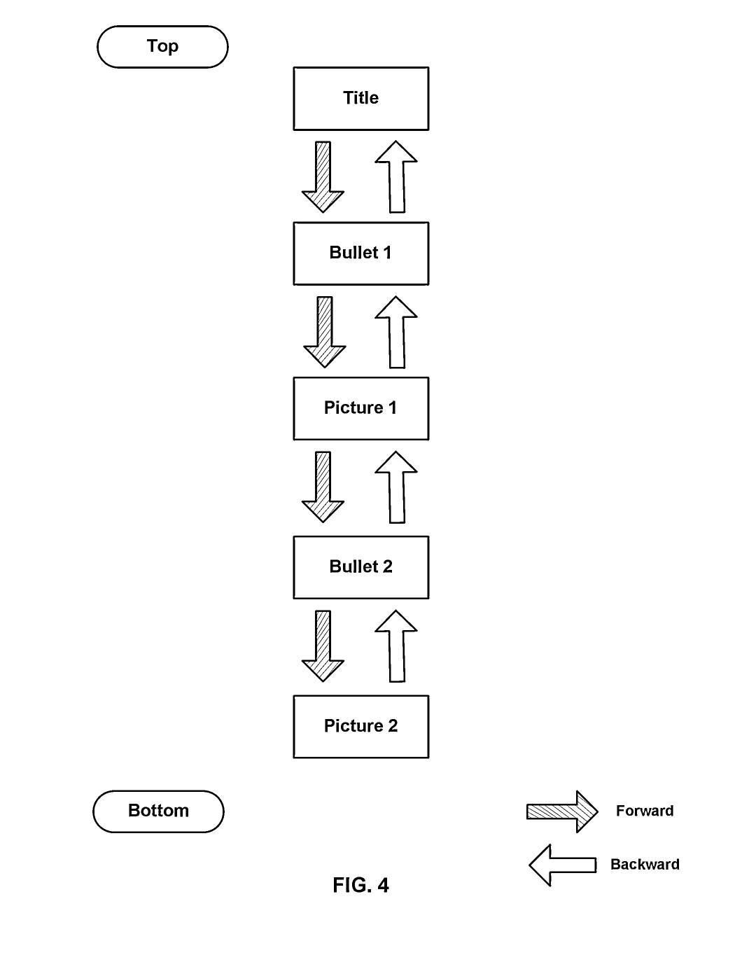

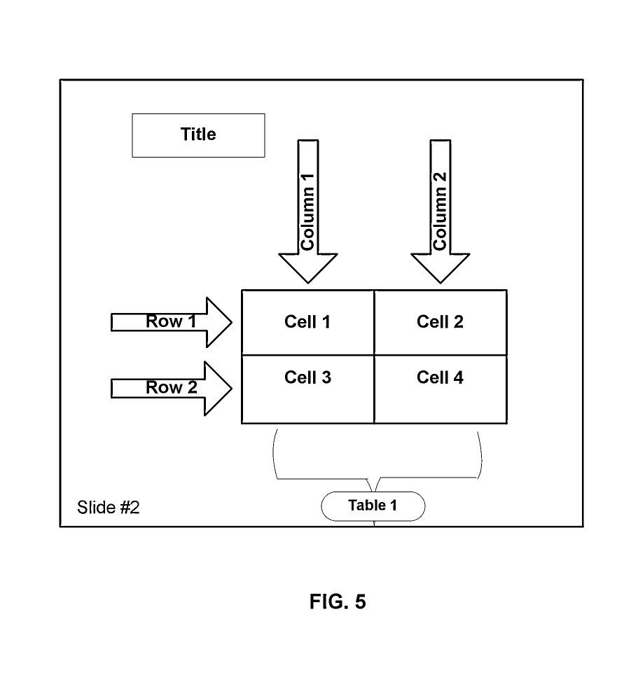

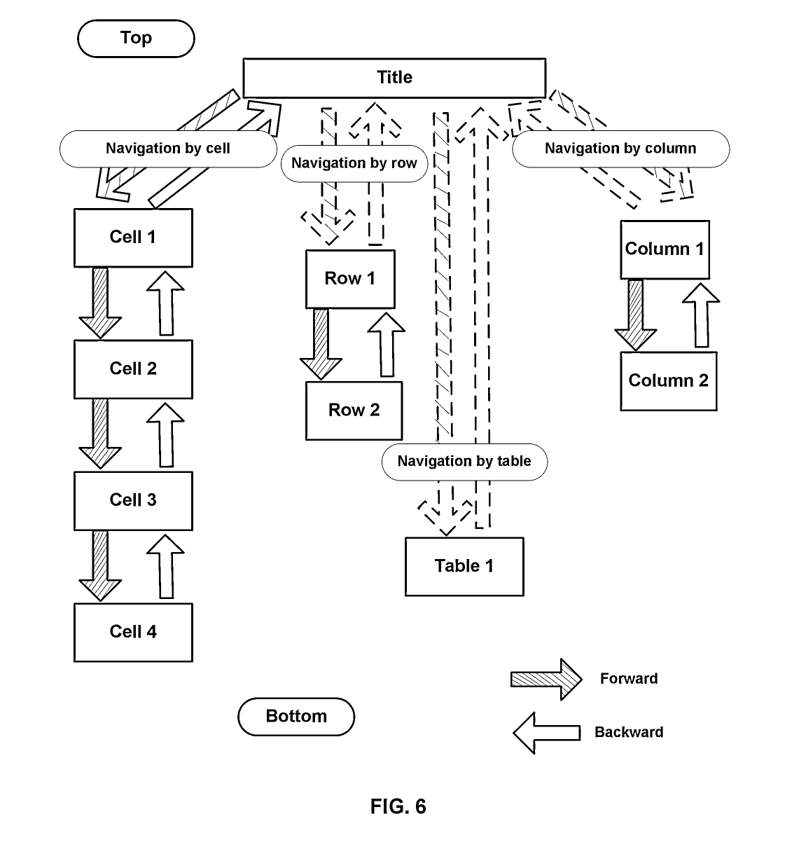

In step 240 the module analyzes all resulting logical shapes and builds a navigation map for this slide (build)—see FIG. 4: Example navigation map of slide #1 (FIG. 3) and FIG. 6: Example navigation map for slide #2 (FIG. 5). The navigation map is used internally in the module in order to provide the user with the option to navigate from shape to shape manually, using some pointing device (in human eye order), i.e. this enables the speaker to easily navigate (e.g. by rotating mouse scroll wheel, pressing Tab/Shift+Tab, etc.) from one logical shape to another—forward and backward.

One way of implementing a navigation map may be a sorted array (from top to bottom). Each time a new logical shape is added to the map, it should be inserted at the proper place preserving the map sorting order from top to bottom and from left to right (or right to left, depending on the presented screen or shape language direction).

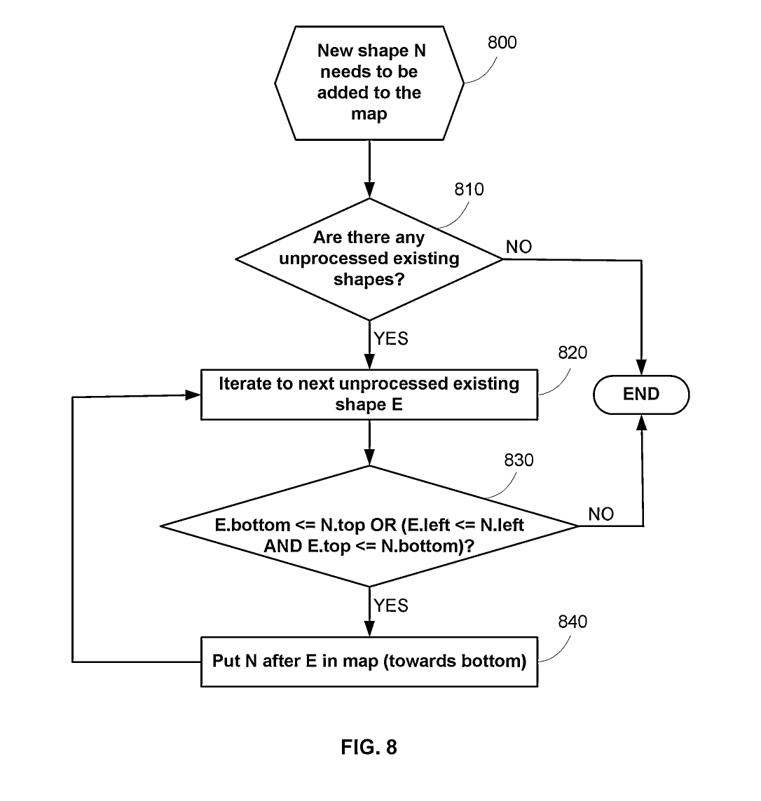

FIG. 8 is a flowchart of an exemplary algorithm for building a navigation map for a next shape. In step 800 a next shape N needs to be added to the navigation map. In step 810, if all current shapes have been processed, the algorithm ends. Otherwise, the next shape E is examined in step 820. In step 830 the coordinates of shapes E and N are compared and next shape N is entered into its appropriate place in the navigation map accordingly.

The module may also automatically advance to the next slide/screen after passing the last logical shape on the current slide/screen in the forward direction and similarly—display the previous slide/screen when passing past the first shape in the backward direction.

The module may also allow different modes of navigation for different shapes. E.g. for table shapes, the user may want to navigate by cell, column, row or entire table—see FIG. 6: Example navigation map for slide #2. For textbox shapes, the user may want to navigate by paragraph or by entire textbox. The defaults for different modes preferences may be configured in the system (shown as solid arrows in the example of FIG. 6).

Returning to FIG. 2, After the navigation map has been calculated, in step 250 the module populates all logical shapes from the navigation map to the module overlay window—marks the space occupied by each logical shape as a hot-spot on the module overlay window—in order to capture user input events on that logical shape and react accordingly.

In order that both child logical shape (e.g. paragraph, cell, row, column) and its parent shape (e.g. textbox, table) will be selectable, the module calculates a proper Z-index for each logical shape on the module overlay window. Thus, e.g. paragraphs will overlay textbox, cells will overlay columns, rows and table; columns and rows will overlay table.

The module constantly monitors (step 260) the current slide/screen and animation build (for slide presentation application). If slide/screen or build changes (step 270), the module returns to the slide/screen detection phase and the process repeats.

### User Actions

Focus: By analyzing user mouse movements on the presented file window, the module enables visual focus tracking of the current logical shape in the mouse focus. For example, the module may draw a dotted line around the logical shape in focus (based on current mouse location).

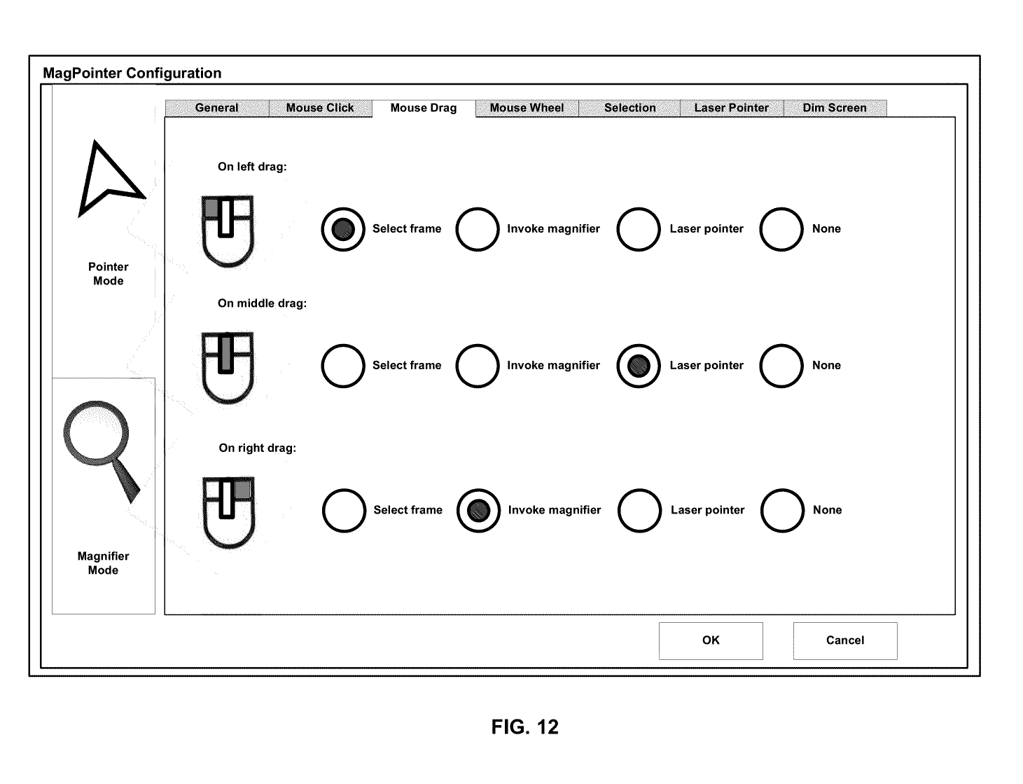

Drag (FIG. 12): By analyzing user mouse movements on the presented file window when combined with pressing and holding a mouse button (mouse drag), the module enables different actions on all drag types. For example, on left button drag, user may draw a rounded rectangle (frame), on middle button drag—show laser pointer, and on right button drag—invoke lens. As an example, laser pointer may be implemented as a semi-transparent custom cursor.

These user drag actions are object-agnostic, i.e. they are not related to specific objects/shapes and they may be performed not only in an application with detectable objects (e.g. PowerPoint, Word, Excel, etc.), but in any application (e.g. picture viewer) or even on the raw desktop window during the course of the presentation or online collaboration meeting.

### Z-Index Calculation Algorithm

In order to allow the user to interact with multiple overlapping logical shapes or frames of different sizes and in different positions relative to each other defined by a drag action as described above, each logical shape or frame should be given a proper Z-index in order to allow the user to reach the shape or frame action buttons without overlapping these action buttons under some other shape or frame (i.e. create vertical continuity).

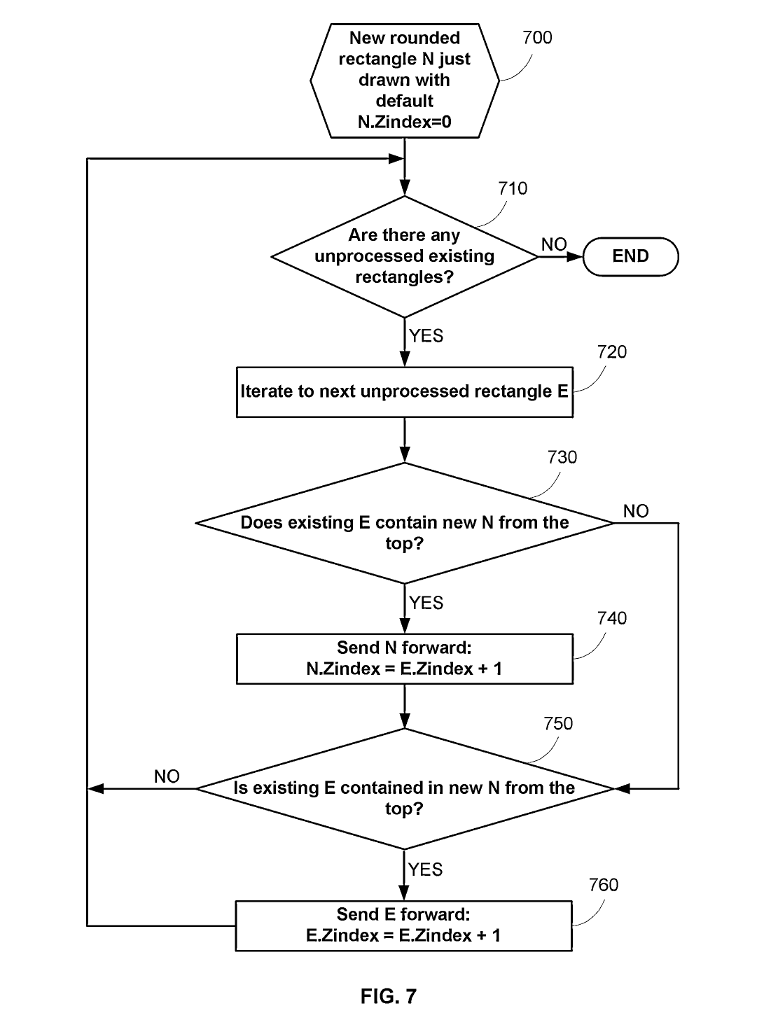

FIG. 7 is a flowchart of an exemplary algorithm for building of Z-index calculation for a new rectangle defined by a drag action for the purpose of e.g. defining an area to be lighted—called frame. In step 700 a new rounded rectangle N (frame) has just been drawn with Z-index=0. In step 710, if all current shapes have been processed, the algorithm ends. Otherwise, newly added rectangle N is compared with already existing rectangles one by one (710, 720). If existing rectangle E is bigger than N (contains/encompasses it), then rectangle N should be on top of this rectangle E in terms of Z-index in order to be able to reach the smaller rectangle N (740).

Similarly, if new rectangle N is bigger than existing rectangle E (contains/encompasses it), then rectangle E should be on top of rectangle N in terms of Z-index in order to be able to reach the smaller rectangle E (760).

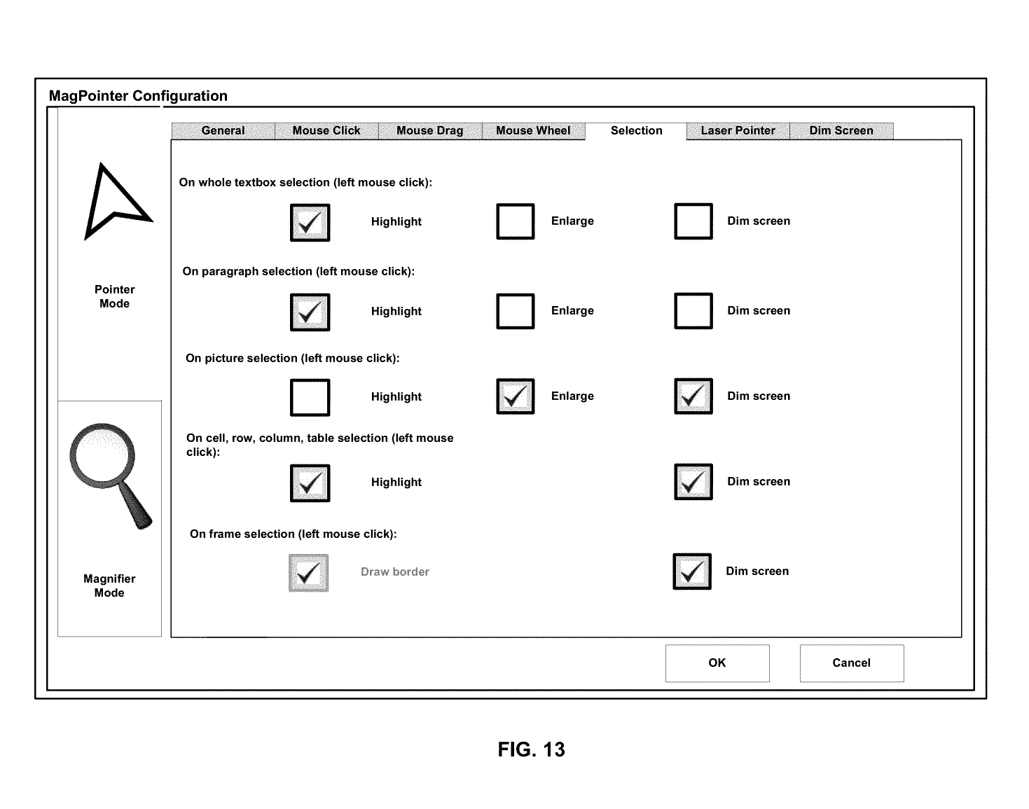

Shape-specific actions: By analyzing user mouse actions (clicks, wheel rotation, etc.) on a logical shape, the module allows the user to perform some shape-specific actions. E.g. left click on a shape may select or unselect it (toggle mode), right click may blur the shape, and rotating mouse wheel may increase or decrease the shape size (and zoom factor—enlarging or shrinking). Upon shape selection, different automatic pre-configured effects may take place—see FIG. 13: Example of configuration—selection in Pointer mode. So, for example, selection of a text/paragraph shape/object may result in highlighting it, selection of a picture shape may magnify it and dim the rest of the screen, selection of a table cell may result in highlighting it and dimming the rest of the screen.

Shape magnification may be performed bitmap-wise (like in lens mode, stretching a bitmap), which can result in some pixelization (bad quality) or vector-wise for better quality without pixelization. E.g. for vector-wise magnification of text, the module may increase the font size of the magnified text shape/object. For high quality magnification of pictures, the module can display the original high resolution image of the magnified picture shape/object as kept in the presentation file (most pictures are kept in the presentation file in high resolution, but are presented during the slideshow with lower resolution to save space on the slide).

Toolbar action buttons: Alternatively, when the user enters or selects/highlights a shape or enters a rounded rectangle (frame), the module may display a toolbar or pop-up of buttons for different user actions relevant for that shape or frame. Clicking on a toolbar button will perform some shape-specific (frame-specific) action, e.g. change highlight color, close highlight/rectangle, magnify, blur.

It is also possible to perform some slide-specific actions when a corresponding toolbar button is pressed, e.g. toggle between single highlight or multiple highlights mode, toggle between single frame or multiple frames mode, etc.

Also, it is possible to perform application specific actions when a corresponding toolbar button is pressed, e.g. move to the next or previous slide/screen, move to the first or last slide/screen, blacken or whiten screen, etc.

Lens mode: When the user invokes the lens (e.g. by dragging the mouse with right button pressed), the module enters into lens operating mode. In this mode, there is one moving lens object (moving according to the user mouse movement) and this lens object combines two different tools: a magnifying glass and a projector. The projector lights only the moving magnifying glass while the rest of the screen is shaded dark. The lens object may be in the shape of a circle, or a rectangle.

In lens operating mode, many user input events may have different interpretation. E.g. mouse wheel rotation and left button drag may control the lens zoom factor, right button drag may control the lens radius (for circular lens) or lens width and height (for rectangular lens), right click may return the user to the default pointer operating mode and so on.

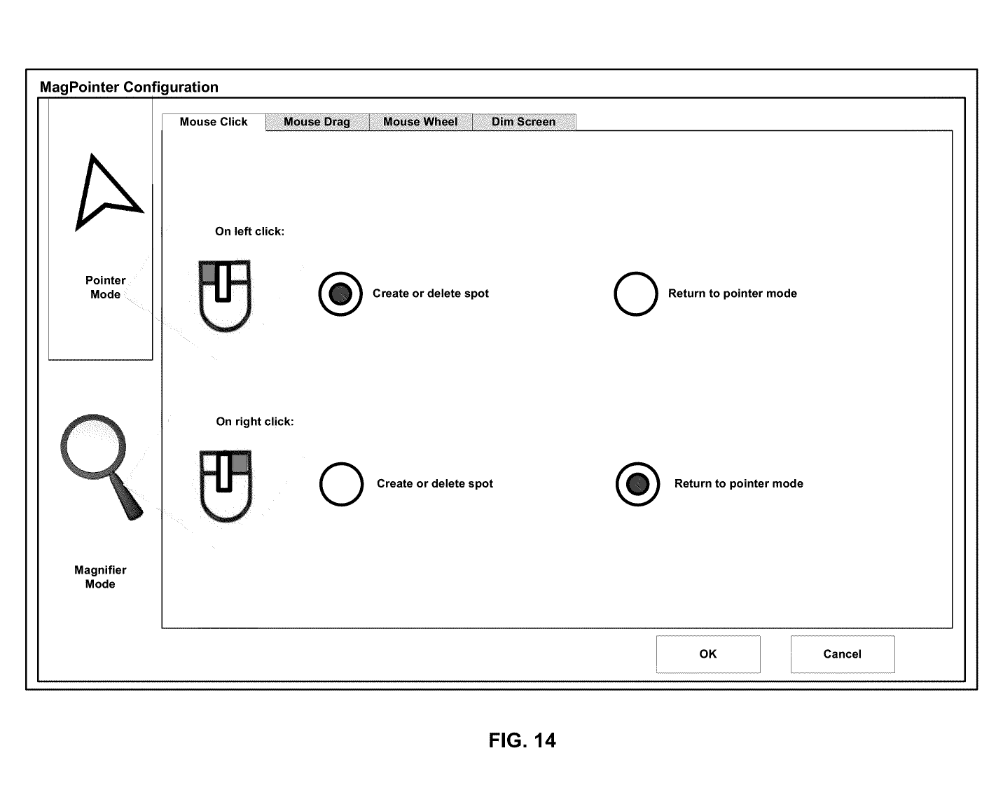

Spots (FIG. 14): in lens mode there is an option to create and delete spots. Spots are static (frozen, non-moving) areas on the slide, which are also lighted (like the moving lens).

A spot is created when the user decides to “freeze” the current state of the moving lens' position, radius and zoom factor (or width and height for rectangular lens) and have the moving lens focus on other areas on the slide. This may be supported by left click on any area empty of other existing spots on the slide (in lens mode).

Removing a spot may be supported, for example, by navigating the moving lens over the spot to be removed and left clicking on it.

Multiple, concurrently visible spots of different sizes, positions and zoom factors may be supported.

### Smartphones

Another kind of user input device during the presentation meeting (in addition to/instead of regular keyboard & mouse devices) may be touch screen surface of a user smartphone. So, for example, by running a mobile application on a smartphone, the user may perform all or some of the user actions described above (shape-specific actions, drag actions, etc.) by performing some finger(s) gestures on the touch screen surface of the smartphone. For this purpose, the running mobile application on a smartphone should be in constant connection (e.g. over Wifi, Bluetooth, 3G, etc.) with the module running on the computer/laptop on which the presentation software runs.

The mobile application may be a dedicated application which supports the functionality and features described in this patent or alternatively, it can be a general-purpose 3^{rd} party off-the-shelf mobile application, which provides general 3-button mouse remote control.

### Bluetooth Headset

Another kind of user input device during the presentation show (in addition to/instead of regular keyboard & mouse devices and touchscreen) may be a Bluetooth headset placed on the presenter ear. The presenter may perform all or some of the user actions described above (shape-specific actions, drag actions, etc.) by talking using a Bluetooth headset and giving voice commands, e.g. “next slide”, “select title”, “select 2^{nd} paragraph” and so on.

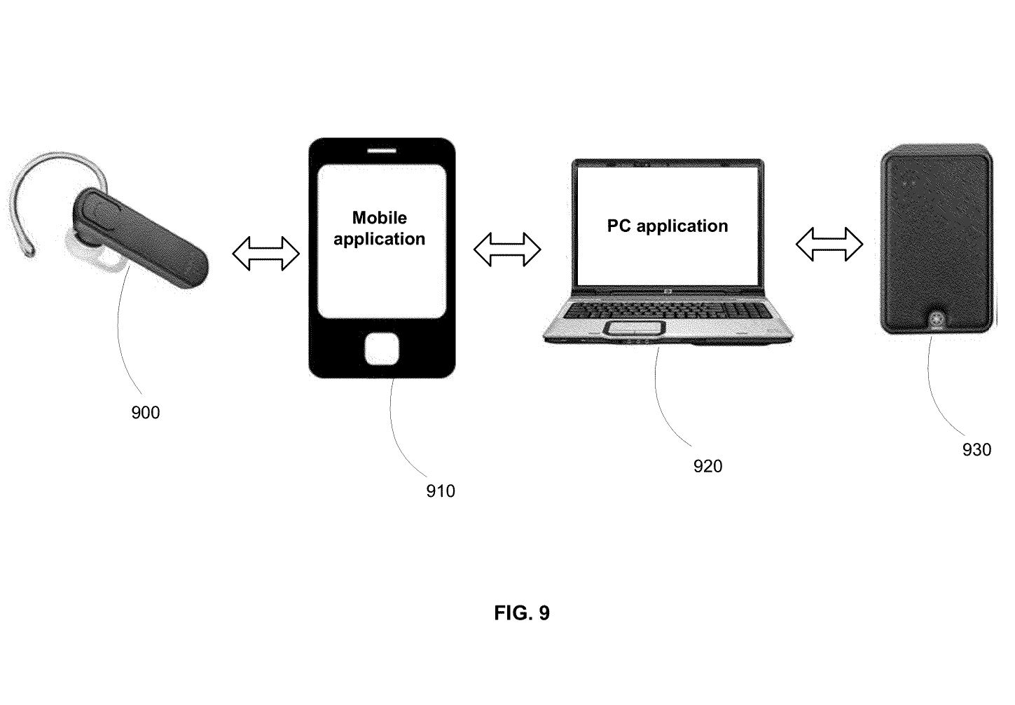

Additional usage of a Bluetooth headset microphone may be for recording the presenter speech and/or amplifying audio by transmitting the user voice from the Bluetooth headset to the user smartphone running a mobile application, further on to the server module on the presentation software machine (computer/laptop) and directing the user voice to connected amplifiers/speakers. FIG. 9 is a schematic representation of an exemplary system comprising a Bluetooth headset 900, a smartphone 910 running a mobile application, a laptop/PC 920 running a PC presentation application and speakers/amplifier 930.

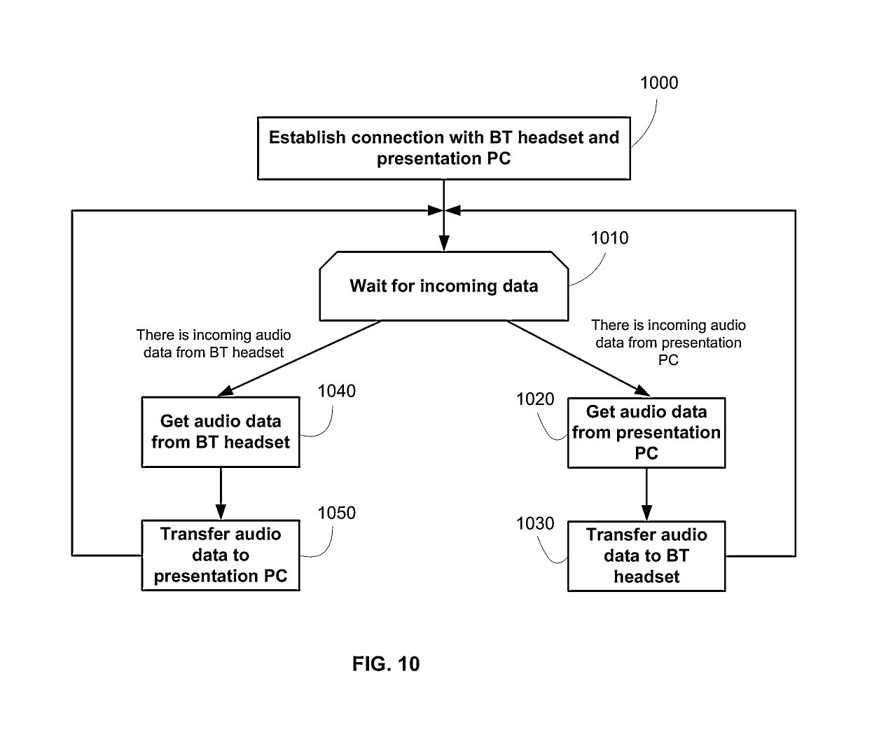

FIG. 10 is a flowchart of a mobile application running on smartphone 910. In step 1000 the smartphone application establishes connection with the Bluetooth headset 900 and with the presentation PC 920. In step 1010 the smartphone application waits for incoming data from either the presentation PC 920 or the Bluetooth headset 900. In step 1020, incoming audio data from the presentation PC 920 is transferred 1030 to the Bluetooth headset 900. In step 1040, incoming audio data from the Bluetooth headset 900 is transferred 1050 to the presentation PC 920.

In addition to the Bluetooth headset microphone, the Bluetooth headset speaker may be used during the presentation to privately relay to the presenter any kind of information (e.g. how much time has elapsed/remains, real slide progress vs. previously projected progress, slide information, etc.). Since the Bluetooth headset speaker is relatively weak, only the presenter wearing the Bluetooth headset will be able to hear this information, not distracting the audience from the show.

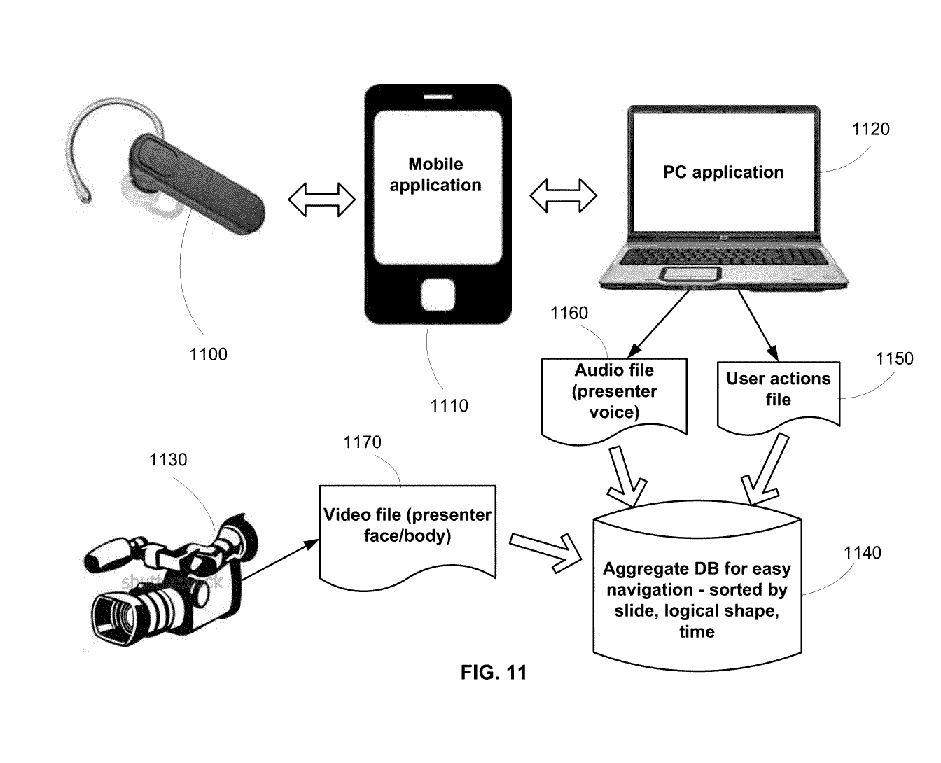

FIG. 11 is a schematic representation of another exemplary system for carrying out the present invention, comprising a mobile application running on a mobile communication device 1110, a Bluetooth headset 1100 and with the presentation PC 1120, similar to the embodiment of FIG. 9. All user actions during the presentation may be recorded together/correlated with the slide/shape information. This can be further enhanced, as shown in the embodiment of FIG. 11, by also recording the presenter's voice (e.g. by a Bluetooth headset microphone) and/or the presenter's face and/or body (by camera—integrated in a smartphone, integrated in a laptop, webcam, professional camera 1130, etc.).

The recorded information (presenter user actions 1150, presenter voice & video 1160, 1170) may be stored in a database 1140 and may later be played back for any selected slide or shape, thus providing a very convenient navigation system.

Compared to existing presentation recording tools which record the presentation screen at a high frame-rate (resulting in a high bit-rate movie), this method has additional (in addition to shape-level convenient navigation) big advantage in the resulting recorded file—the recorded file is much smaller (user actions are recorded only when they occur vs. constant screen recording).

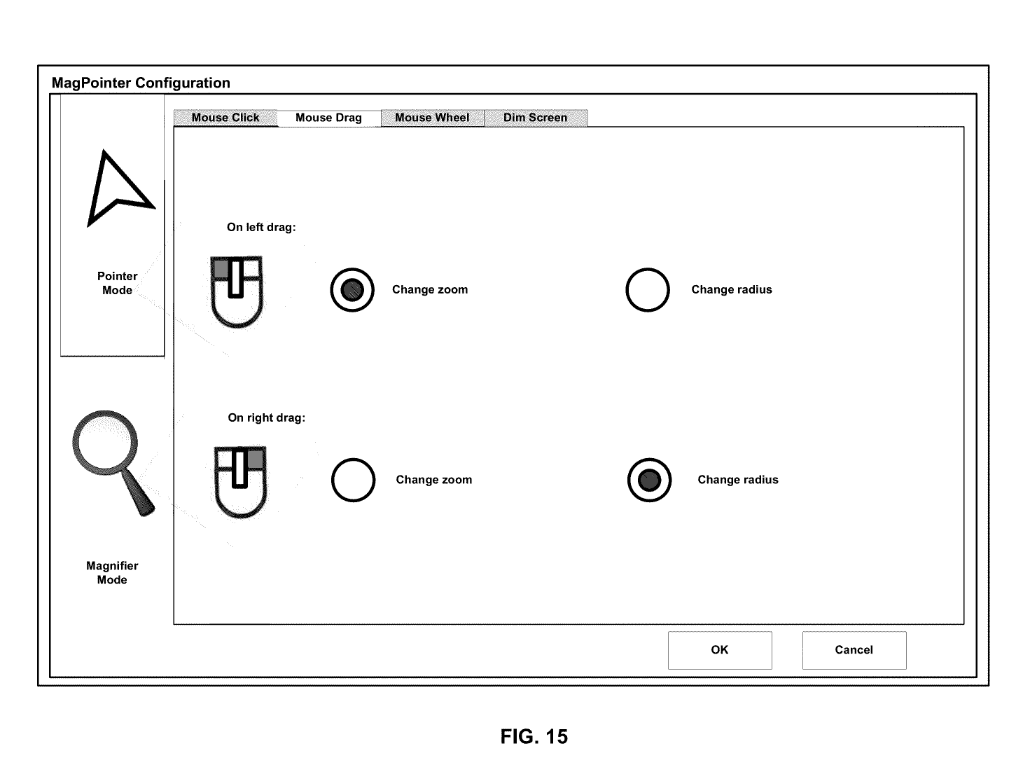

FIGS. 12 through 15 show screen captures of a configuration module of the presentation application according to the present invention. The exemplary screens show various modes of configuring the presenter's interaction with the system and the resulting effects.

### Statistics, Analytics & Benchmarking

When the invention/module is deployed in a mid-size or large company, it may be beneficial to gather usage statistics during the presentation meeting—e.g. how much time was spent on each slide or shape, how many times each slide or shape was displayed/selected, etc.

When the same document (slide presentation, spreadsheet, text, PDF, etc.) is presented multiple times to different audiences by different company presenters (e.g. in sales, marketing or training departments), the accumulated statistics for this document may be processed and may provide valuable analytics & benchmarking, that may be used to improve the quality of the presented document, presenters presentation skills or the company's product presented. Various benchmarks may then be calculated to offer comparisons of presenters, documents presented or products presented.

This analytics & benchmarking component may be an independent application or a service provided over the cloud by a 3rd party (e.g. Salesforce, Microsoft Dynamics, SAP, etc.).

### Design-Time Plug-In

Another tool helpful in achieving more comprehensible presentations by resolving overloaded slides or visual clutter problem may be a design-time automatic analysis of the content of each slide and giving each slide a quality grade. E.g. grade range may be 1 to 10, when 1 means highly overloaded and poorly designed slide (in terms of objects, colors, etc.) and 10 means very clear, simple and well-designed slide. This quality grade is calculated based on the number of objects and sub-objects (like paragraphs, cells) on the slide, their areas, colors, margins, total empty slide area and other factors.

This tool is intended to be used in design-time (not slideshow mode). As an example it may be implemented as PowerPoint plug-in with dedicated controls on PowerPoint ribbon.

The user may act upon these analysis results to improve his presentation by e.g. manually splitting over-loaded slides.

Alternatively, the analysis plug-in may be further designed to automatically provide end user means for improving low-scoring slides (polishing poor-designed slides).

One of such means may be splitting a complex, overloaded slide into several simpler slides with fewer objects in each slide according to user input—user specifies number of simpler slides and for each object on the complex slide he specifies the simpler slide sequence number or numbers (if the object should appear in several simpler slides). After receiving such user input, the design-time presentation system plug-in may automatically split the overloaded slide into several simpler slides, producing clearer and more professional slides.

Alternatively or additionally, the design-time presentation system plug-in can offer a user to build a presentation system animation consisting of several phases for each selected slide, where each animation phase will show only part of the slide's objects. This animation building process can be done automatically according to user input—user specifies number of animation phases for each selected slide and for each object on the complex/overloaded slide he specifies the animation phase sequence number or numbers (if the object should appear in several animation phases), or for each phase, the user specifies which objects should appear in that phase. After receiving such user input, the design-time presentation system plug-in will automatically convert the overloaded slide into slide with animation, when at each animation phase the screen looks clearer and more professional (since fewer number of objects will be visible simultaneously).

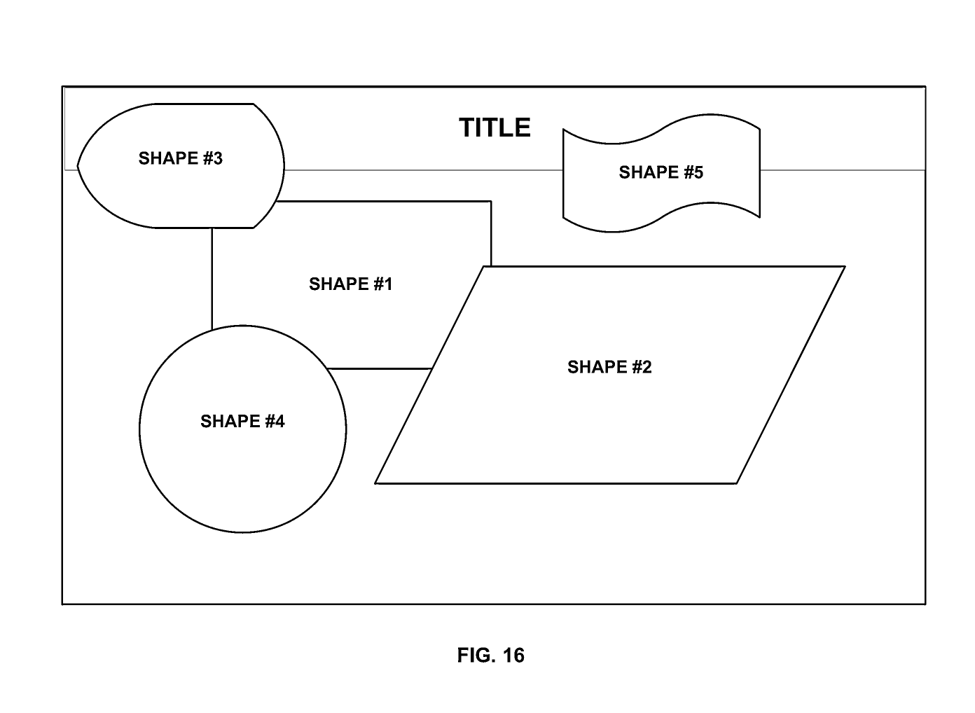

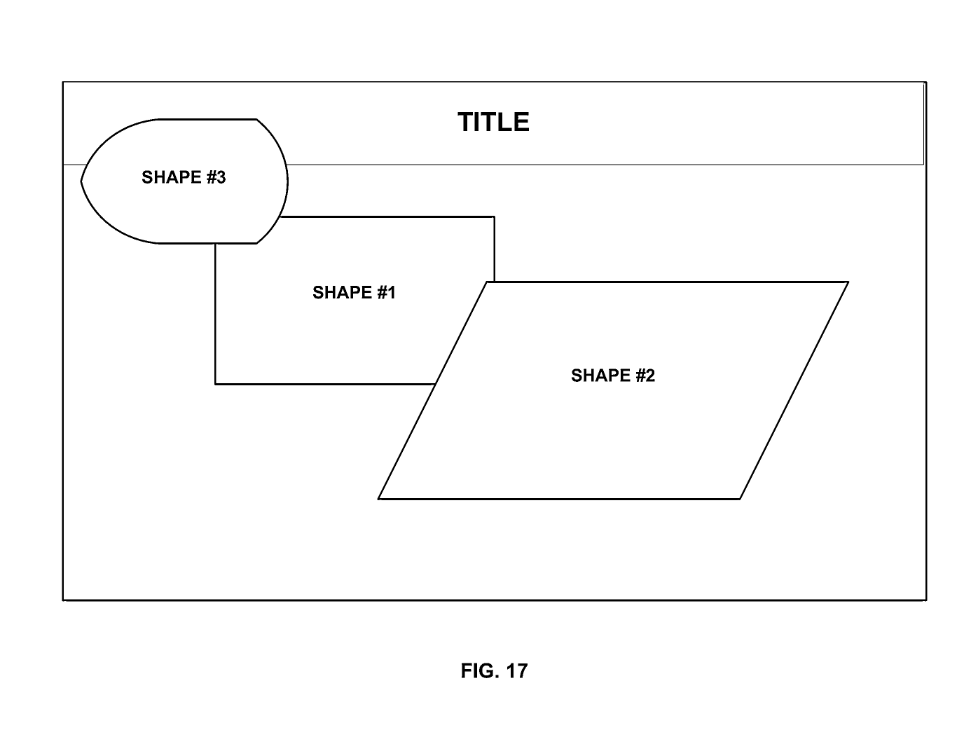

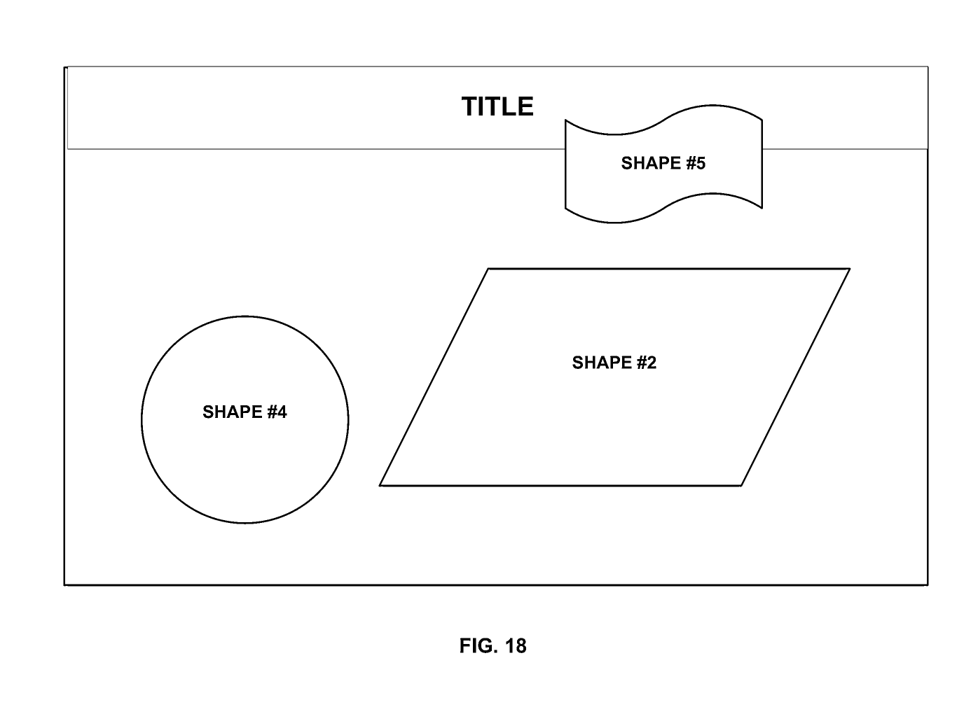

FIGS. 16 through 18 show an exemplary “cluttered” slide (FIG. 16) divided by the system into two simpler slides (FIGS. 17 and 18) to replace original slide 16. Note that shape #2 and the title are common to both partial slides.

The idea of these “visual clutter killer” means is to provide the user with a very simple, intuitive and straightforward way to easily split slides or build animation for users who don't know how to do it (e.g. build animation in PowerPoint) or for users who don't do it because of the big effort involved.

In order to implement the method of the present invention, a computer (not shown) may receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations of methods, apparatus (systems) and computer program products according to embodiments of the invention. It will be understood that each portion of the flowchart illustrations and combinations of portions in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or portions.

The aforementioned flowchart and diagrams illustrate the architecture, functionality, and operation of possible implementations of systems, methods and computer program products according to various embodiments of the present invention. In this regard, each portion in the flowchart may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

It is to be understood that the phraseology and terminology employed herein is not to be construed as limiting and are for descriptive purpose only.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. An interactive presentation and collaboration system comprising:
a computer system comprising:
at least one CPU, memory, a display, at least one input device and at least one storage unit adapted to store at least one presentation,
said computer system adapted to run a presentation program and an interactive presentation enhancement module configured to:
detect a presentation window being displayed on said display;
detect all the shapes in said presentation window;
break down each one of said detected shapes into logical shapes;
receive user commands pertaining to a selected one or more of said logical shapes;
change the display of said selected one or more logical shapes according to said user command; and
dim the display surrounding said selected one or more logical shapes according to predefined configuration.

2. (canceled)

3. (canceled)

4. The system of claim 1, wherein said interactive presentation enhancement module is further configured to change the displayed presentation window in said select shape mode by selecting from the group consisting of: highlighting said selected shape and changing the dimensions of said selected shape.

5. (canceled)

6. The system of claim 4, wherein said selected shape is a first picture and wherein said interactive presentation enhancement module is further configured to change the displayed presentation window by displaying entirely or partly a second full resolution picture stored in said presentation, corresponding to said first picture.

7. The system of claim 2, wherein said user commands comprise magnifier mode commands selected from the group consisting of: displaying a magnified area, changing the zoom of said displayed magnified area, changing the radius of said displayed magnified area and defining one or more static lighted spots on said currently displayed presentation window.

8. The system of claim 1, additionally comprising GUI means for configuring the interactive presentation enhancement module, said GUI means configured to define the mode of receiving said user commands and define the display change according to said received user commands.

9. (canceled)

10. The system of claim 1, wherein said interactive presentation enhancement module is further configured to automatically navigate between all said logical shapes presented in a currently displayed presentation window.

11. The system of claim 10, wherein said navigating comprises navigating between logical shapes contained in another logical shape.

12. The system of claim 11, wherein said navigating between logical shapes contained in another logical shape comprises one of navigating between one of: cells, rows and columns contained in a table and navigating between paragraphs contained in a text box.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. The system of claim 1, further comprising a transparent or semi-transparent overlay window on top of the displayed presentation window, said overlay window configured to populate all said logical shapes and intercept all user keyboard and mouse events.

26. The system of claim 25, wherein said presentation enhancement module is further configured to calculates a Z-index for each logical shape on the overlay window.

27. An interactive presentation and collaboration method comprising:
detecting a presentation window being displayed on a computer display;
detecting all the shapes in said presentation window;
breaking down each one of said detected shapes into logical shapes;
receiving user commands pertaining to a selected one or more of said logical shapes;
changing the display of said selected one or more logical shapes according to said user command; and
dimming the display surrounding said selected one or more logical shapes according to predefined configuration.

28. (canceled)

29. (canceled)

30. (canceled)

31. (canceled)

32. The method of claim 27, wherein said selected shape is a first picture and wherein said changing the displayed presentation window comprises displaying entirely or partly a second full resolution picture stored in said presentation, corresponding to said first picture.

33. The method of claim 28, wherein said magnifier mode commands comprise one of: displaying a magnified area, changing the zoom of said displayed magnified area, changing the dimensions of said displayed magnified area and defining one or more static lighted spots on said currently displayed presentation window.

34. The method of claim 27, additionally comprising configuring said interactive presentation method, comprising defining the mode of receiving said user commands and defining the display change according to said received user commands.

35. (canceled)

36. The method of claim 27, additionally comprising automatically navigating between all the logical shapes presented in a currently displayed presentation window.

37. The method of claim 36, wherein said navigating comprises navigating between logical shapes contained in another logical shape.

38. The method of claim 37, wherein said navigating between logical shapes contained in another logical shape comprises one of navigating between one of: cells, rows and columns contained in a table and navigating between paragraphs contained in a text box.

39. (canceled)

40. (canceled)

41. (canceled)

42. (canceled)

43. (canceled)

44. (canceled)

45. (canceled)

46. (canceled)

47. (canceled)

48. (canceled)

49. The method of claim 27, further comprising displaying a transparent or semi-transparent overlay window on top of the displayed presentation window;
populating all said logical shapes on the overlay window; and
intercepting all user keyboard and mouse events in said overlay window.

50. The method of claim 49, further comprising calculating a Z-index for each logical shape on the overlay window.

51. (canceled)

52. (canceled)

53. (canceled)

54. (canceled)

55. (canceled)

56. (canceled)

57. (canceled)

58. (canceled)

59. (canceled)
